(19) United States
(12) Patent Application Publication
(10) Pub. No.: US 2018/0256425 A1
(43) Pub. Date: Sep. 13, 2018

(54) Line Guiding Assembly

(71) Applicant: Lynet Lingenfelter, Grass Valley, CA (US)

(72) Inventor: Lynet Lingenfelter, Grass Valley, CA (US)

(21) Appl. No.: 15/452,063

(22) Filed: Mar. 7, 2017

(51) Int. Cl. A61G 7/05; A61G 7/018; F16L 3/223

(52) U.S. Cl. CPC A61G 7/0524; F16L 3/223; A61G 7/018

(57) ABSTRACT

A line guiding assembly for organizing tubes, lines and wires utilized in treatment of a patient includes a bed rail that is coupled to a bed frame. A panel is coupled to and extends upwardly from the bed rail such that a top of the panel extends past a mattress that is positioned on the bed frame. A plurality of couplers is coupled to the panel proximate to the top of the panel. An orifice, which is circularly shaped, is positioned through the panel. A fan is coupled to the panel and is positioned in the orifice. The couplers are configured to selectively couple to the tubes, the lines and the wires that are utilized in the treatment of the patient who is positioned on the mattress. The fan is configured to motivate air across the patient.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to line guiding assemblies and more particularly pertains to a new line guiding assembly for organizing tubes, lines and wires utilized in treatment of a patient.

### BRIEF SUMMARY OF THE INVENTION

An embodiment of the disclosure meets the needs presented above by generally comprising a bed rail that is coupled to a bed frame. A panel is coupled to and extends upwardly from the bed rail such that a top of the panel extends past a mattress that is positioned on the bed frame. A plurality of couplers is coupled to the panel proximate to the top of the panel. An orifice, which is circularly shaped, is positioned through the panel. A fan is coupled to the panel and is positioned in the orifice. The couplers are configured to selectively couple to the tubes, the lines and the wires that are utilized in the treatment of the patient who is positioned on the mattress. The fan is configured to motivate air across the patient.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a line guiding assembly according to an embodiment of the disclosure.

FIG. 2 is a back view of an embodiment of the disclosure.

FIG. 3 is an in-use view of an embodiment of the disclosure.

FIG. 4 is an isometric perspective view of an embodiment of the disclosure.

FIG. 5 is an in-use view of an embodiment of the disclosure.

### DETAILED DESCRIPTION OF THE INVENTION

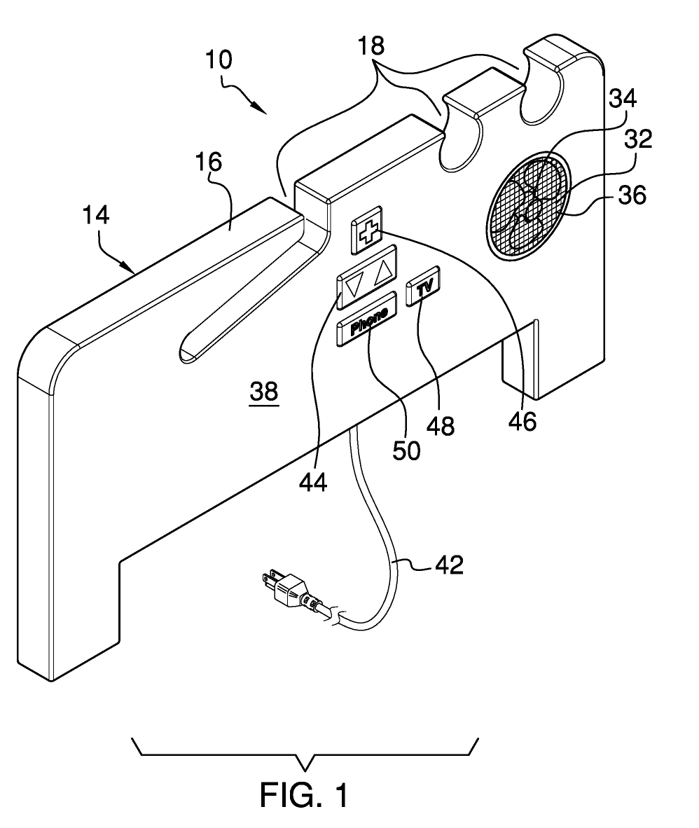

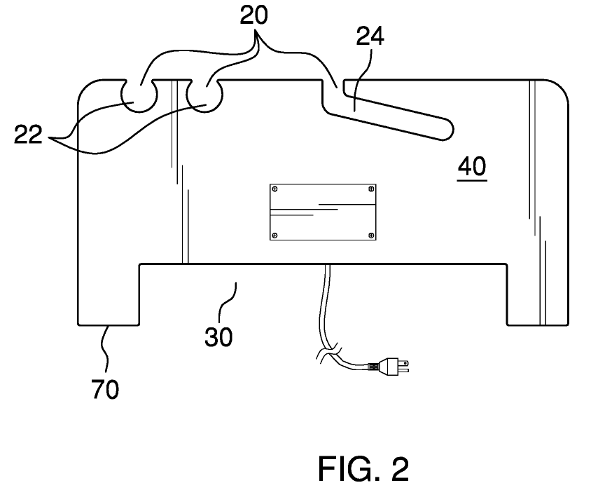

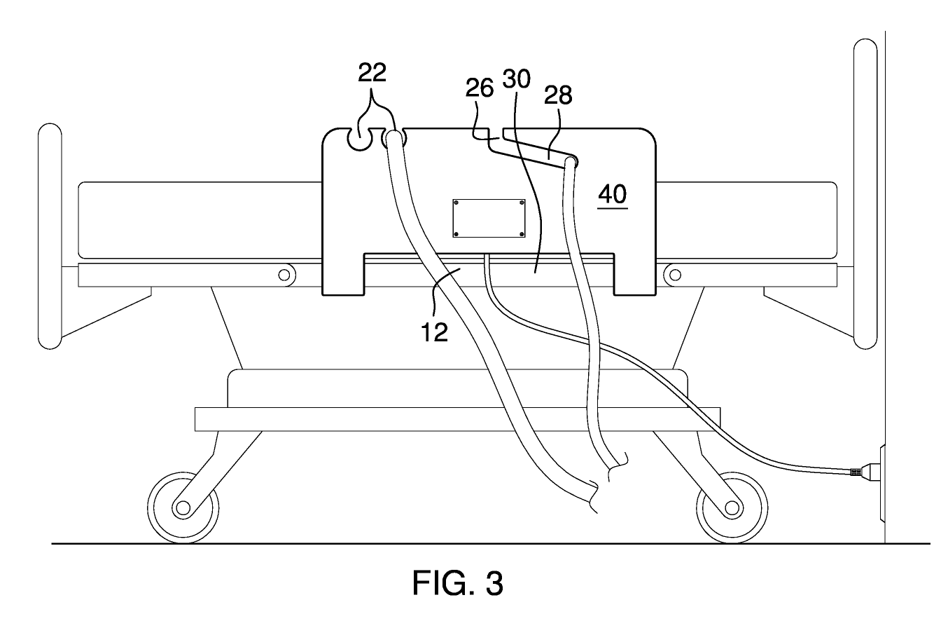

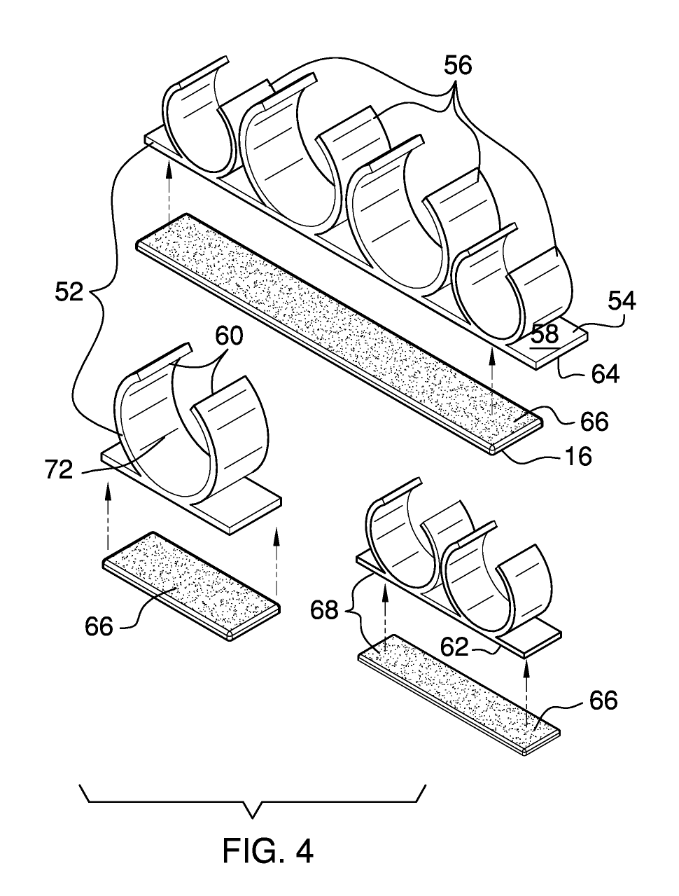

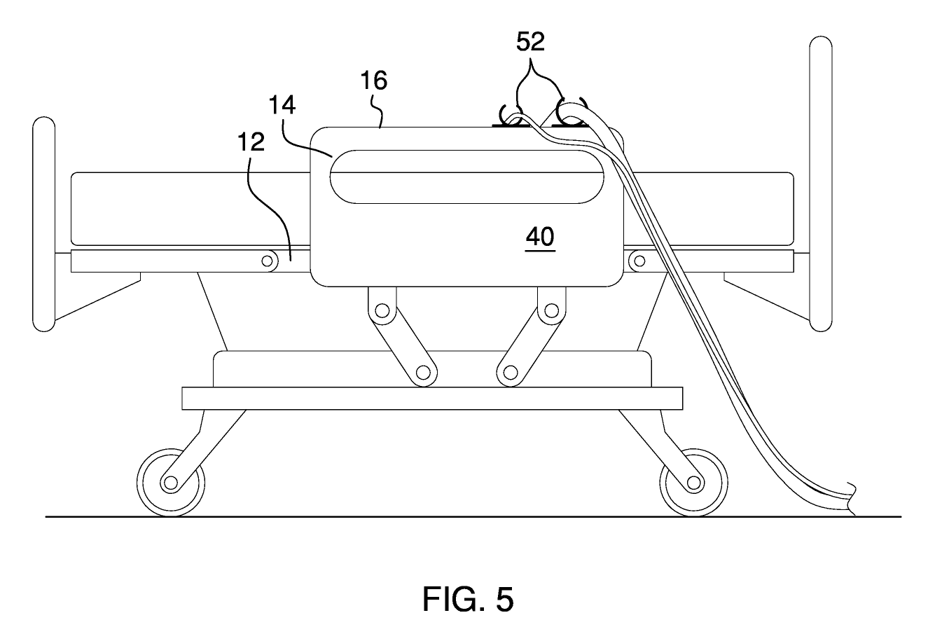

With reference now to the drawings, and in particular to FIGS. 1 through 5 thereof, a new line guiding assembly embodying the principles and concepts of an embodiment of the disclosure and generally designated by the reference numeral 10 will be described.

As best illustrated in FIGS. 1 through 5, the line guiding assembly 10 generally comprises a bed rail 12 that is coupled to a bed frame. A panel 14 is coupled to and extends upwardly from the bed rail 12 such that a top of the panel 14 extends past a mattress that is positioned on the bed frame. In one embodiment, the panel 14 is substantially rectangularly shaped.

A plurality of couplers 18 is coupled to the panel 14 proximate to the top 16 of the panel 14. The couplers 18 are configured to selectively couple to tubes, lines and wires that are utilized in the treatment of a patient who is positioned on the mattress.

In one embodiment, the plurality of couplers 18 comprises a plurality of first cutouts 20. The first cutouts 20 are positioned in the panel 14 adjacent to the top 16. In another embodiment, the plurality of first cutouts 20 comprises a pair of first slots 22 and a second slot 24. The first slots 22 are arcuate. The second slot 24 has a first section 26 and a second section 28. The first section 26 extends perpendicularly from the top 16 into the panel 14. The second section 28 extends transversely from the first section 26 distal from the top 16 of the panel 14.

In one embodiment, a second cutout 30 is substantially centrally positioned in a bottom 70 the panel 14. The second cutout 30 is substantially rectangularly shaped.

An orifice 32 is positioned through the panel 14. The orifice 32 is circularly shaped. A fan 34 is coupled to the panel 14 and is positioned in the orifice 32. The fan 34 is configured to motivate air across the patient. In one embodiment, the fan 34 is positioned below the pair of first slots 22.

The assembly 10 comprises a pair of grates 36. The grates 36 are complementary to the orifice 32. Each grate 36 is coupled singly to a first side 38 and a second side 40 of the panel 14. The grates 36 are positioned to enclose the fan 34.

A power cord 42 is coupled to the panel 14. The power cord 42 is configured to couple the panel 14 to a source of alternating current. The power cord 42 is operationally coupled to the fan 34.

A controller 44 is coupled to the panel 14. The controller 44 is operationally coupled to the power cord 42. The controller 44 is configured to control a configuration of the bed frame.

A first button 46, a second button 48, and a third button 50 are coupled to the first side 38 of the panel 14. The first button 46 is configured to notify medical personnel of a need of the patient. The second button 48 is configured to activate a television that is positioned proximate to the patient. The third button 50 is configured to activate a phone that is positioned proximate to the patient.

In an alternative embodiment of the invention, the plurality of couplers 18 comprises a plurality of connectors 52. The connectors 52 are configured to couple to the top 16 of the panel 14. The connectors 52 are configured to selectively couple to the tubes, the lines and the wires that are utilized in the treatment of a patient who is positioned on the mattress.

In one embodiment, each connector 52 comprises a slat 54 that is substantially rectangularly shaped. A plurality of clamps 56 is coupled to and extends from an upper face 58 of the slat 54. Each clamp 56 is selectively couplable to a respective one of the tubes, the lines and the wires that are utilized in the treatment of a patient who is positioned on the mattress.

In another embodiment, the plurality of clamps 56 comprises from one to four clamps 56. In yet another embodiment, each clamp 56 comprises a pair of arms 60. The arms 60 are arcuate and define a partial circle 72. The arms 60 are deformable. The arms 60 are selectively separable to insert a respective one of the tubes, the lines and the wires that are utilized in the treatment of the patient who is positioned on the mattress.

A first fastener 62 is coupled to a bottom face 64 of the slat 54. A second fastener 66 is coupled to the top 16 of the panel 14. The second fastener 66 is complementary to the first fastener 62. The second fastener 66 is positioned to selectively couple to the first fastener 62 to couple the slat 54 to the panel 14. The clamps 56 are positioned to selectively couple to the tubes, the lines and the wires that are utilized in the treatment of the patient who is positioned on the mattress. In still yet another embodiment, the first fastener 62 and the second fastener 66 comprise a hook and loop fastener 68.

In use, the couplers 18 are configured to selectively couple to the tubes, the lines and the wires that are utilized in the treatment of the patient who is positioned on the mattress. The fan 34 is configured to motivate air across the patient.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A line guiding assembly comprising:
a bed rail coupled to a bed frame;
a panel coupled to and extending upwardly from said bed rail such that a top of said panel extends past a mattress positioned on the bed frame;
a plurality of couplers coupled to said panel proximate to said top of said panel;
an orifice positioned through said panel, said orifice being circularly shaped;
a fan coupled to said panel and positioned in said orifice; and
wherein said couplers are positioned on said panel such that said couplers are configured for selectively coupling to tubes, lines and wires utilized in treating a patient positioned on the mattress, wherein said fan is positioned in said panel such that said fan is configured for motivating air across the patient.

2. The assembly of claim 1, further including said panel being substantially rectangularly shaped.

3. The assembly of claim 1, further including a second cutout substantially centrally positioned in a bottom said panel, said second cutout being substantially rectangularly shaped

4. The assembly of claim 1, further including said plurality of couplers comprising a plurality of first cutouts positioned in said panel adjacent to said top.

5. The assembly of claim 4, further including said plurality of first cutouts comprising a pair of first slots and a second slot, said first slots being arcuate, said second slot having a first section and a second section, said first section extending perpendicularly from said top into said panel, said second section extending transversely from said first section distal from said top of said panel.

6. The assembly of claim 1, further including said plurality of couplers comprising a plurality of connectors, said connectors being configured for coupling to said top of said panel, wherein said connectors are positioned on said panel such that said connectors are configured for selectively coupling to the tubes, the lines and the wires utilized in treating the patient positioned on the mattress.

7. The assembly of claim 6, further including each said connector comprising:
a slat, said slat being substantially rectangularly shaped;
a plurality of clamps coupled to and extending from an upper face of said slat, each said clamp being selectively couplable to a respective one of the tubes, the lines and the wires utilized in treating the patient positioned on the mattress, said plurality of clamps comprising from one to four said clamps;
a first fastener coupled to a bottom face of said slat;
a second fastener coupled to said top of said panel, said second fastener being complementary to said first fastener; and
wherein said second fastener is positioned on said slat such that said second fastener is positioned for selectively coupling to said first fastener to couple said slat to said panel positioning said clamps for selectively coupling to the tubes, the lines and the wires utilized in treating the patient positioned on the mattress.

8. The assembly of claim 7, further including each said clamp comprising a pair of arms, said arms being arcuate defining a partial circle, said arms being deformable such that said arms are selectively separable for inserting a respective one of the tubes, the lines and the wires utilized in treating the patient positioned on the mattress.

9. The assembly of claim 7, further including said first fastener and said second fastener comprising a hook and loop fastener.

10. The assembly of claim 5, further including said fan being positioned below said pair of first slots.

11. The assembly of claim 1, further including a power cord coupled to said panel, said power cord being configured for coupling said panel to a source of alternating current, said power cord being operationally coupled to said fan.

12. The assembly of claim 11, further including a controller coupled to said panel, said controller being operationally coupled to said power cord, said controller being configured for controlling a configuration of the bed frame.

13. The assembly of claim 1, further including a first button coupled to a first side said panel, said first button being configured for notifying medical personnel of a need of the patient.

14. The assembly of claim 1, further including a second button coupled to a first side said panel, said second button being configured for activating a television positioned proximate to the patient.

15. The assembly of claim 1, further including a third button coupled to a first side said panel, said third button being configured for activating a phone positioned proximate to the patient.

16. The assembly of claim 1, further including a pair of grates, said grates being complementary to said orifice, each said grate being coupled singly to a first side and a second side of said panel such that said grates are positioned for enclosing said fan.

17. A line guiding assembly comprising:
a bed rail coupled to a bed frame;
a panel coupled to and extending upwardly from said bed rail such that a top of said panel extends past a mattress positioned on the bed frame, said panel being substantially rectangularly shaped;
a plurality of couplers coupled to said panel proximate to said top of said panel, wherein said couplers are positioned on said panel such that said couplers are configured for selectively coupling to tubes, lines and wires utilized in treating a patient positioned on the mattress, said plurality of couplers comprising a plurality of first cutouts positioned in said panel adjacent to said top, said plurality of first cutouts comprising a pair of first slots and a second slot, said first slots being arcuate, said second slot having a first section and a second section, said first section extending perpendicularly from said top into said panel, said second section extending transversely from said first section distal from said top of said panel;
a second cutout substantially centrally positioned in a bottom said panel, said second cutout being substantially rectangularly shaped;
an orifice positioned through said panel, said orifice being circularly shaped;
a fan coupled to said panel and positioned in said orifice, wherein said fan is positioned in said panel such that said fan is configured for motivating air across the patient, said fan being positioned below said pair of first slots;
a power cord coupled to said panel, said power cord being configured for coupling said panel to a source of alternating current, said power cord being operationally coupled to said fan;
a controller coupled to said panel, said controller being operationally coupled to said power cord, said controller being configured for controlling a configuration of the bed frame;
a first button coupled to a first side said panel, said first button being configured for notifying medical personnel of a need of the patient;
a second button coupled to said first side said panel, said second button being configured for activating a television positioned proximate to the patient;
a third button coupled to said first side said panel, said third button being configured for activating a phone positioned proximate to the patient; and
a pair of grates, said grates being complementary to said orifice, each said grate being coupled singly to said first side and a second side of said panel such that said grates are positioned for enclosing said fan; and
wherein said couplers are positioned on said panel such that said couplers are configured for selectively coupling to the tubes, the lines and the wires utilized in treating the patient positioned on the mattress, wherein said fan is positioned in said panel such that said fan is configured for motivating air across the patient

18. The assembly of claim 17, further including said plurality of couplers comprising a plurality of connectors, said connectors being configured for coupling to said top of said panel, wherein said connectors are positioned on said panel such that said connectors are configured for selectively coupling to the tubes, the lines and the wires utilized in treating the patient positioned on the mattress, each said connector comprising:
a slat, said slat being substantially rectangularly shaped,
a plurality of clamps coupled to and extending from an upper face of said slat, each said clamp being selectively couplable to a respective one of the tubes, the lines and the wires utilized in treating the patient positioned on the mattress, said plurality of clamps comprising from one to four said clamps, each said clamp comprising a pair of arms, said arms being arcuate defining a partial circle, said arms being deformable such that said arms are selectively separable for inserting a respective one of the tubes, the lines and the wires utilized in treating the patient positioned on the mattress,
a first fastener coupled to a bottom face of said slat, and
a second fastener coupled to said top of said panel, said second fastener being complementary to said first fastener, said first fastener and said second fastener comprising a hook and loop fastener; and
wherein said second fastener is positioned on said slat such that said second fastener is positioned for selectively coupling to said first fastener to couple said slat to said panel positioning said clamps for selectively coupling to the tubes, the lines and the wires utilized in treating the patient positioned on the mattress.
